(19) United States
(12) Patent Application Publication
(10) Pub. No.: US 2015/0046565 A1
(43) Pub. Date: Feb. 12, 2015

(54) SYSTEM AND METHOD FOR ARCHIVING MESSAGES

(71) Applicant: Quicktext Inc., Redwood City, CA (US)

(72) Inventors: Resat Nuri Otus, Hillsborough, CA (US); Roger S. Sanford, San Jose, CA (US); David Thomas Harper, Orinda, CA (US)

(21) Appl. No.: 14/454,680

(22) Filed: Aug. 7, 2014

Related U.S. Application Data
(60) Provisional application No. 61/863,813, filed on Aug. 8, 2013.

(51) Int. Cl. G06F 11/14; H04L 29/08

(52) U.S. Cl. CPC G06F 11/1448; H04L 67/1097
USPC 709/217

(57) ABSTRACT

A computer-implemented method for archiving messages is disclosed. The method comprises monitoring messages associated with a messaging application running on a messaging device; detecting at least one message marked for archiving; and sending each message marked for archiving to an archiving server for storage in association with a user account.

### PRIORITY

This application claims the benefit of priority to U.S. Provisional Patent Application No. 61/863,813 entitled SYSTEM AND METHOD FOR ARCHIVING MESSAGES and which was filed Aug. 8, 2013, the entire specification of which is incorporated herein by reference.

### FIELD

The present disclosure relates to messages and in particular to messages sent and received via mobile devices.

### BACKGROUND

The proliferation of mobile devices such as mobile phones and tablet computers in recent years has led to messaging becoming a popular way of communication both for personal and business communications. One messaging protocol is the Short Message Service (SMS) protocol. The volume of SMS messages sent on a daily basis is staggering.

Generally, the messages that are routinely sent and received are of an ephemeral nature and do not need archiving. But, increasingly, business related messages, which are traditionally communicated via email, are now being sent via messaging applications.

Thus, there is a need to archive messages such as SMS messages that is being fueled by the trend towards using messaging applications to send and receive business related messages.

### SUMMARY

According to a first aspect of the invention, a computer-implemented method for archiving messages is disclosed. The method comprises monitoring messages associated with a messaging application running on a messaging device; detecting at least one message marked for archiving; and sending each message marked for archiving to an archiving server for storage in association with a user account.

Other aspects of the invention will be apparent from the detailed description below.

### BRIEF DESCRIPTION OF THE DRAWINGS

FIG. 1 shows a deployment scenario in accordance with one embodiment of the invention in which a messaging device runs a client archiving application configured to send archiving messages to a remote archiving application running on an archiving server.

FIG. 2 shows a sequence of operations performed by the client archiving application, in accordance with one embodiment of the invention.

FIG. 3 shows a sequence of operations performed by the remote archiving application, in accordance with one embodiment of the invention.

FIG. 4 shows a sample report generated by the remote archiving application, in accordance with one embodiment of the invention.

FIG. 5 shows exemplary hardware for implementing the archiving server, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block or flow diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to the details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

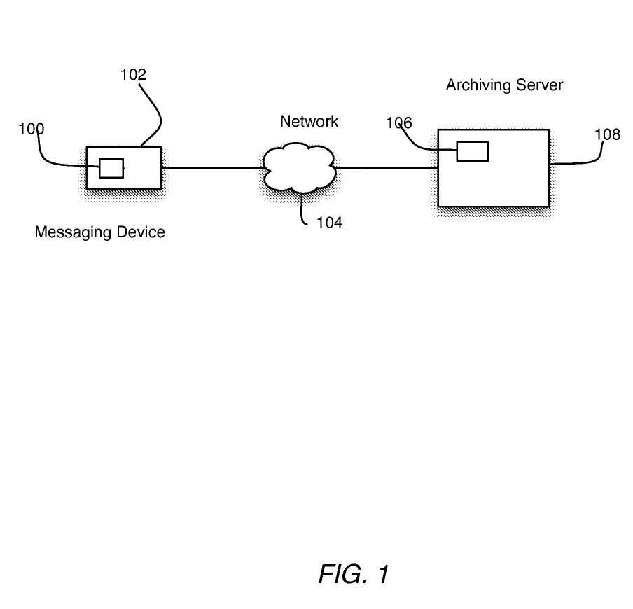

Referring to FIG. 1 of the drawings, a client archiving application 100 is provisioned to run on a messaging device 102 such as a mobile phone.

In one embodiment, the application 100 is configured to archive messages sent and received via the device 102 as will be described.

In one embodiment, messages to be archived are transmitted to a remote archiving application 106. Said remote archiving application may be running on an archiving device, e.g. in the form of an archiving server 108.

Transmission of the messages to be archived may be via an intermediate network 104. In accordance with difference embodiments, the network 104 may include a WiFi network, a wide area network (WAN) such as the Internet, etc.

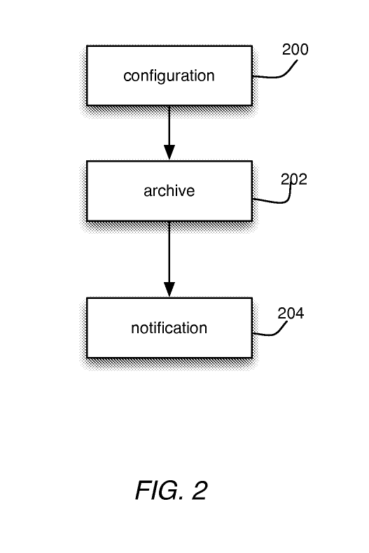

In one embodiment, the application 100 may support the processing blocks shown in FIG. 2. Referring to FIG. 2, at block 200 a configuration operation is performed. This operation captures various inputs from a user to enable an archiving of messages, e.g. SMS, MMS messages, or messages from Over the top data (ott) services such as WhatsApp and wechat. For example, the configuration operation may capture user account information (user name and password) and archiving preferences from a user. In one embodiment, the archiving preferences may specify an archiving schedule comprising archiving events. During each archiving event, the client archiving application transmit the messages to be archived to the remote archiving application. Said schedule may include a frequency with for the archiving events and a time of day at which to perform the archiving events. In one embodiment, the archiving schedule may be specified in terms of a predefined volumes of messages marked for archiving that must be accumulated before an archiving event occurs. For this embodiment, the messages marked for archiving are sent in a message batch comprising all the messages marked for archiving since the last archiving event.

In one embodiment, the archiving preferences may include specification of a special archiving character(s) in a message subject that may denote to the application 100 that a message is to be included for archival or to be excluded. For example, a “#” in a message subject or in a message body at a designated location (e.g. at the beginning) may effectively mark a message for inclusion or exclusion in the next archiving event.

In another embodiment, the archiving character may indicate the preference for the message or recent messages to be archived into a particular system of choice or format of choice. For example, archiving characters in the form of the string “#deal” may indicate that the most recent messages involved a negotiation that should be archived to an appropriate sales or CRM system that hold sales data.

In another embodiment, a user may select particular conversations to be archived based on different criteria. For example based on a selection of recipients or participants from a list of conversations. The selection may be based on selection of contact metadata associated with a contact such as name, address, or selection of phone numbers or email.

In one embodiment, a message may be annotated with a special character(s) to indicate that said message is to be archived. This is particularly useful in cases where a message lacks an archiving character(s) and yet is to be archived.

In another embodiment, the decision about which conversations are archived may be made based on the business relationship information from external data sources. This may be accomplished by obtaining a list of the business contacts from a list that is made available locally, or by an internet service, such as a REST API, to the device. The list will contain first and last names, phone numbers, emails or address information. The business relationship information may include information about the state of business dealings with a contact, such as a lead, account, sale or other similar customer relationship information. The list of information described above is matched against the information available on the phone such as the phone number and name, in order to decide which text messaging sessions have business relevance and are thus marked for archiving.

In another embodiment, the archival of a particular conversation may be to a particular backup location based on the conversation annotation. The annotation would correspond to a business or consumer service location remote to the messaging device.

In one embodiment, information associated with a message may be identified and treated as an annotation based on natural language processing to detect semantic information such as a scheduled event, deal, etc.

In another embodiment, the client archiving app 100 may contextually scan the text of the messages in order to determine if a particular message warrants further attention. The scan may look for interesting words in the text which imply locations, dates, times, dollar amounts, names, technical terms, product information, etc. The client archiving app 100 may be configured to assemble a list of such possible interesting events such that the user can then choose an activity to perform. The activities may take a chunk of information and back up the data to a particular 3^{rd} party data storage location, CRM or other similar system.

In one embodiment, the data format of archived messages may comprise at least a conversation container which includes the parties involved (receivers, sender). In terms of message data, there may be text or binary data, including multimedia information such as pictures or videos. Messages may also include date, time, send state information and location information.

At block 202, the application 100 performs the archiving operation. In accordance with different embodiments, steps under the archiving operation may include encrypting messages since the last archive event and transmitting the encrypted messages to the archiving application 106 via the network 104. In one embodiment, the archiving operation may also transmit message sender/recipient information associated with each message, and the time of that each message was sent or received. In one embodiment, an entire message conversation may be transmitted for archiving by the archiving application 106.

In one embodiment, at block 204, the application 100 may provide periodic notifications in the form of a status report to a user to indicate a success or failure of the last performed archiving operation.

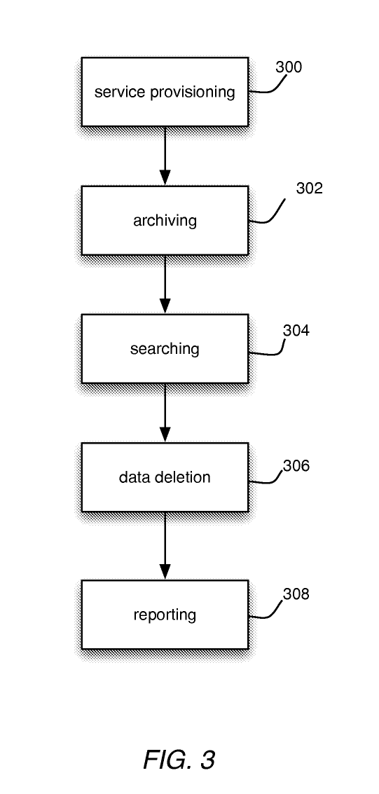

FIG. 3 shows the operations performed by the archiving application 108 in accordance with one embodiment. Referring to FIG. 3, at block 300, a service-provisioning step is performed. Under this step a user account may be created to facilitate archiving and service provisioning information is configured. Service provisioning information may include the internet location of a relay pipeline, direct data store locations for media, REST API service locations, encryption requirements around stored data, requirements of a company to backup all data versus the employee choosing which conversations to backup, any encryption key or other similar information as required by data privacy law or legal agreement, the location of the archiving servers over an ip network, and any credentials required to access the archiving location and upload data to it. The service provisioning information may enable multimodal archiving designed to use a standardized transport container format such as xml, json or encrypted json to carry the data to various possible network destinations and systems.

At block 302, an archiving step is performed. This step includes receiving an archiving request from the application 100, responsive to which the authentication of the user is performed. Once the user is authenticated, the messages that are received from the application 100 are prepared for archiving. The latter step may include formatting the messages, e.g. into pdf format, json, or other format. Thereafter, the messages may be stored in memory an associated with the user's account.

Upon archiving, the creation of the corresponding data structures in a local data store on the messaging device occurs, as is identical or largely similar to those on the (remote) server side of the messaging and archiving services. This includes the conversation and corresponding message/conversation data.

In one embodiment, the messaging app may be configured to monitor new conversations across multiple messaging services. When a new conversation is detected, the messaging app uses a standard string or pattern matching algorithm to determine if the parties involved in the new conversation match the parties in an earlier conversation. Thus, a unified view of conversations between the same parties across multiple messaging services may be presented. The data used for matching will include the metadata of the contact, such as phone numbers, email, and address data for that person, such that a contact from one service may be matched based on the phone number, email or any other available information to the same contact in a messaging service. The attempt will be made also, by comparing the same information, to correlate any conversations from one message storage provider (such as SMS or iMessage) with another (such as WhatsApp or WeChat).

The messages may be stored (on the messaging device) in any number of formats, including as a file based storage format, incremental storage container, database or other similar storage structure, such as a json document based NoSQL storage server, or relational store.

There is also the need to, in the case where the text message is stored to a file system, secure the data such that the dates, times and recipients associated with the message cannot be altered after the data has been uploaded from the messaging device. In one embodiment, the dates and recipients of the messages may be used along with a private key to generate a checksum or may be separately encrypted such that the decryption of that data will match the unencrypted stored data. The encrypted data may be decrypted using a key available to the archiving server and the messaging device itself that holds a private encryption key.

In some embodiments, the stored messages may be indexed for search. At block 304, the application 108 performs a search operation to locate particular messages based on a search query initiated by the user. The search query may be performed locally on a messaging device, and allows a user to locate and identify messages to the user as backed up from one or multiple message services. The messages may be searched based on the content or metadata of the messages, starting with the conversation containers, users involved, and their contact information such as phone numbers, emails and addressed.

In a further embodiment, the search may comprise the search of any multimedia data that may be attached to a message. The goal of that search would be to extract any recorded audio information first and make such a transcript to be available in a text record. The search would be a text search of that transcript in addition to any content that is purely text.

In one embodiment, the application 108 may execute data deletion block 306. The block 306 may be configured to delete messages based on certain predefined message deletion criteria (e.g. messages that are older than a defined age) or based on a search query at the instance of the user to select messages for deletion. In one embodiment, the deletion criteria may be based on compliance requirements set by legislation.

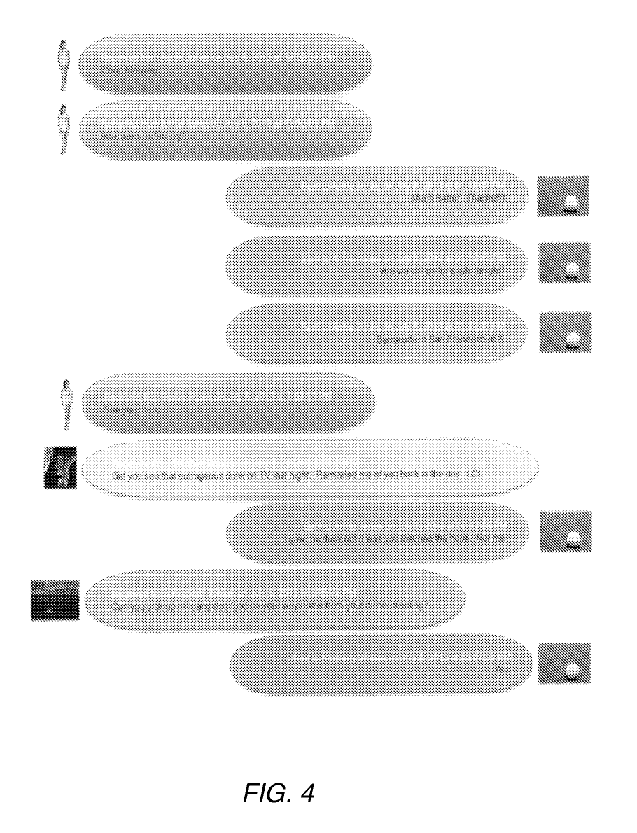

In one embodiment, the application may execute the block 308 to report on messages stored by the system. FIG. 4 shows a report generated in accordance with one embodiment. In one embodiment, a report of text messages sent and received may be sent via email to a user.

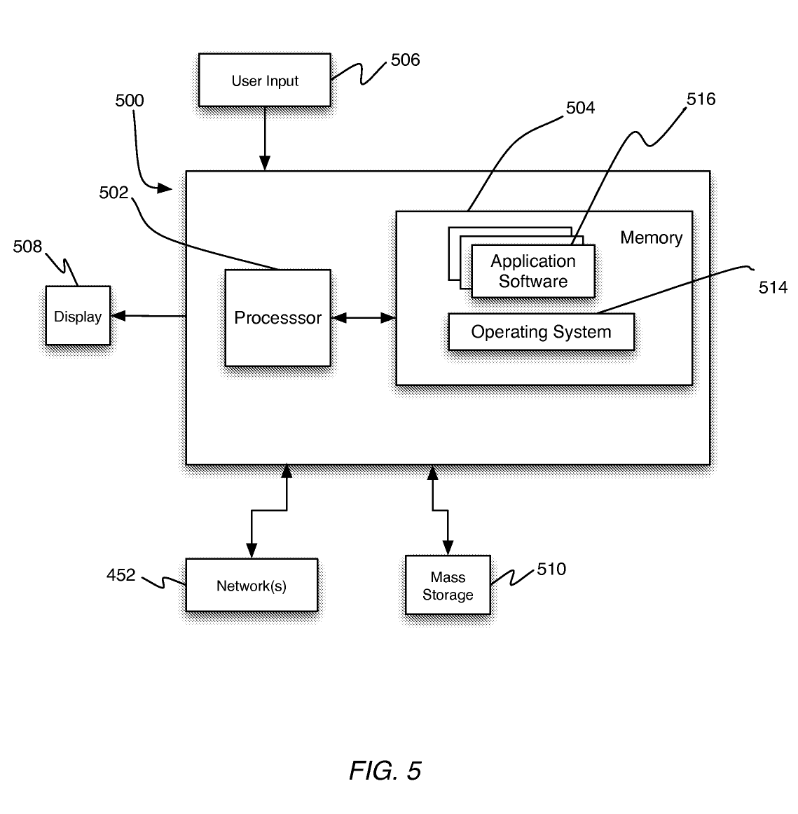

FIG. 5 shows a system 500, in accordance with one embodiment for implementing the archiving server described herein. The system 500 may includes at least one processor 502 coupled to a memory 504. The processor 502 may represent one or more processors (e.g., microprocessors), and the memory 504 may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory 504 may be considered to include memory storage physically located elsewhere in the hardware, e.g. any cache memory in the processor 502, as well as any storage capacity used as a virtual memory, e.g., as stored on a mass storage device.

The system also typically receives a number of inputs and outputs for communicating information externally. For interface with a user or operator, the hardware may include one or more user input/output devices 506 (e.g., keyboard, mouse, etc.) and a display 508. For additional storage, the system 500 may also include one or more mass storage devices 510, e.g., a Universal Serial Bus (USB) or other removable disk drive, a hard disk drive, a Direct Access Storage Device (DASD), an optical drive (e.g. a Compact Disk (CD) drive, a Digital Versatile Disk (DVD) drive, etc.) and/or a USB drive, among others. Furthermore, the hardware may include an interface with one or more networks 512 (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor 502 and each of the components, as is well known in the art.

The system 500 operates under the control of an operating system 514, and executes application software 516 which includes various computer software applications, components, programs, objects, modules, etc. to perform the techniques described above.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

1. A computer-implemented method for archiving messages, comprising:
monitoring messages associated with a messaging application running on a messaging device;
detecting at least one message marked for archiving; and
sending each message marked for archiving to an archiving server for storage in association with a user account.

2. The method of claim 1, wherein detecting each message marked for archiving is based on at least one archiving character included in the message.

3. The method of claim 1, wherein sending each message for archiving is based on an archiving schedule comprising defined archiving events.

4. The method of claim 3, wherein each archiving event is scheduled to occur based on a specified time period.

5. The method of claim 3, wherein each archiving event is scheduled to occur based on a predefined number of messages marked for archiving.

6. The method of claim 1, further comprising creating a message batch comprising messages marked for archiving since the last archiving event; and sending said message batch to the archiving server during the next archiving event.

7. The method of claim 1, further comprising generating an archiving status report.

8. The method of claim 7, wherein the archiving status report indicates a success or failure of a last archiving event.

9. The method of claim 1, wherein sending each message comprises identifying the message as part of a conversation; and sending all messages in the conversation to the archiving server.

10. A computer-readable medium having stored thereon a sequence of instructions which when executed by a system causes the system to perform a method for archiving messages, the method comprising:
monitoring messages associated with a messaging application running on a messaging device;
detecting at least one message marked for archiving; and
sending each message marked for archiving to an archiving server for storage in association with a user account.

11. The computer-readable medium of claim 10, wherein detecting each message marked for archiving is based on at least one archiving character included in the message.

12. The computer-readable medium of claim 10, wherein sending each message for archiving is based on an archiving schedule comprising predefined archiving events.

13. The computer-readable medium of claim 12, wherein each archiving event is scheduled to occur based on a specified time period.

14. The computer-readable medium of claim 12, wherein each archiving event is scheduled to occur based on a predefined number of messages marked for archiving.

15. The computer-readable medium of claim 10, wherein the method further comprises creating a message batch comprising messages marked for archiving since the last archiving event; and sending said message batch to the archiving server during the next archiving event.

16. The computer-readable medium of claim 10, wherein the method further comprises generating an archiving status report.

17. The computer-readable medium of claim 16, wherein the archiving status report indicates a success or failure of a last archiving event.

18. The computer-readable medium of claim 10, wherein sending each message comprises identifying the message as part of a conversation; and sending all messages in the conversation to the archiving server.

19. A system, comprising:
a processor; and
a memory coupled to the processor, the memory storing instructions which when executed by the processor causes the system to perform a method for archiving messages, the method comprising:
monitoring messages associated with a messaging application running on a messaging device;
detecting at least one message marked for archiving; and
sending each message marked for archiving to an archiving server for storage in association with a user account.

20. The system of claim 19, wherein detecting each message marked for archiving is based on at least one archiving character included in the message.

21. The system of claim 19, wherein sending each message for archiving is based on an archiving schedule comprising predefined archiving events.

23. The system of claim 21, wherein each archiving event is scheduled to occur based on a specified time period.

23. The system of claim 21, wherein each archiving event is scheduled to occur based on a predefined number of messages marked for archiving.

24. The system of claim 19, wherein the method further comprises creating a message batch comprising messages marked for archiving since the last archiving event; and sending said message batch to the archiving server during the next archiving event.

25. The system of claim 19, wherein the method further comprises generating an archiving status report.

26. The system of claim 25, wherein the archiving status report indicates a success or failure of a last archiving event.

27. The system of claim 19, wherein sending each message comprises identifying the message as part of a conversation; and sending all messages in the conversation to the archiving server.

28. The system of claim 19, wherein detecting each message marked for archiving is based on at least one archiving character included in the message.

29. The system of claim 19, wherein sending each message for archiving is based on an archiving schedule comprising defined archiving events.

30. The system of claim 21, wherein each archiving event is scheduled to occur based on a specified time period.
